(19) United States
(12) Patent Application Publication
(10) Pub. No.: US 2017/0359603 A1
(43) Pub. Date: Dec. 14, 2017

(54) Viewer tailored dynamic video compression using attention feedback

(71) Applicant: James Alexander Levy, Palo Alto, CA (US)

(72) Inventor: James Alexander Levy, Palo Alto, CA (US)

(21) Appl. No.: 15/589,719

(22) Filed: May 8, 2017

Related U.S. Application Data
(60) Provisional application No. 62/348,104, filed on Jun. 9, 2016.

(51) Int. Cl. H04N 21/235; H04N 21/2343; H04N 21/81; H04N 21/25

(52) U.S. Cl. CPC H04N 21/2353; H04N 21/252; H04N 21/234345; H04N 21/812

(57) ABSTRACT

The invention is a video compression method and device utilizing attention data collected from advertisers and by attention sensors in display units carried by one or multiple viewers. The attention data is sent to a server where it is used to produce an aggregated attention map in which attention data from multiple viewers are combined. Aggregated attention data maps produced from multiple reruns of the same video are combined to produce rerun-aggregated attention maps. The rerun-aggregated attention maps are given a timestamp. Anticipated attention maps are produced by selecting a rerun-aggregated attention map with a later time stamp. The advertiser's attention maps, viewer's attention maps, aggregated attention maps, rerun-aggregated attention maps, and anticipated rerun-aggregated attention maps are combined to produce a viewer tailored attention map which is used to compress video data. The compressed video data is sent to the viewers' displays where it is decompressed and displayed.

### FIELD OF THE INVENTION

This invention claims the benefit of U.S. Provisional Application No. 62/348,104 with the same title, “Viewer tailored dynamic video compression using attention feedback” filed on Jun. 9, 2016 and which is hereby incorporated by reference. Applicant claims priority pursuant to 35 U.S.C. Par 119(e)(i). The present invention relates to video compression using audience attention data for virtual reality systems.

### BACKGROUND

Virtual reality systems typically utilize 360-degree video. Communicating or storing such video data can be very demanding in bandwidth and storage, and tradeoffs need to be made between resolution, latency and the width of the field of vision. Visual attention data such as eye tracking has been collected from one or more viewers to generate saliency maps in video images, which can then be employed to compress video data (Reference 4).

Yet, no prior art exists in which attention data is given persistence, that is, old attention data slowly decays as it is replaced by new attention data.

No prior art exists in which saliency or attention maps aggregated from multiple viewers in combination with a saliency or attention map from one particular viewer is used to tailor video resolution for this particular viewer.

No prior art exists in which aggregation of attention from multiple viewers is obtained over many reruns of the same video data, yet used in combination with attention data obtained in real time from a particular viewer to improve on the resolution of the video sent in real time to this particular viewer.

No prior art exists in which video data is presented to a viewer with anticipated resolution.

Further features, aspects, and advantages of the present invention over the prior art will be more fully understood when considered with respect to the following detailed description and claims.

### INCORPORATION BY REFERENCE

The following is incorporated by reference.
1) Semiautomatic Visual-Attention modeling and its application to video compression, Yury Gitman, Mikhail Erofeev, Dmitriy Vatolin, Bolshakov Andrey, Fedorov Alexey; Lomonosov Moscow State University, Institute for Information Transmission Problems.
2) Visual attention guided bit allocation in video compression, Zhicheng Li; Shiyin Qin, Laurent Itti, Image and Vision Computing journal homepage: www.elsevier.com.
3) Visual attention guided video compression; Zhicheng Li; Laurent Itti, Vision Sciences Society Annual Meeting; May 2008.
4) Automatic Foveation for Video Compression Using a Neurobiological Model of Visual Attention Laurent Itti, IEEE Transaction on Image Processing Vol 13, No. 10, pp. 1304-1318, October 2004.
5) U.S. Pat. No. 8,515,131 by Koch, et al.
6) U.S. Pat. No. 8,675,966 by Tang.
7) U.S. Pat. No. 8,098,886 by Koch, et al.
8) US Patent Application 20120106850 by Koch et al.
9) Attention Guided MPEG Compression for Computer Animations, Rafal Mantiuk, Karol Myszkowski, Sumanta Pattanaik, In: Proc. of the 19th Spring Conference on Computer Graphics, pp. 239-244, 2003

### SUMMARY OF THE INVENTION

Providing a user with a uniformly high resolution over the whole field of view is not necessary for multiple reasons, one of which is that the human eye provides the greatest resolution at the fovea. Furthermore, any particular scene may have a few objects that most people would consider of greatest interest. Therefore, when multiple users are viewing the same scene, they usually focus their common attention to a particular (i.e., the most interesting) part of the scene.

The invention utilizes audience attention feedback to adapt bit streaming or allocate bandwidth of a communication system to various areas of a video image presented in real time to one or several viewers. The invention is particularly useful in virtual reality (VR) applications, both recorded and live, because of the high bandwidth requirement for media covering a field of 360 degrees, but can also be used to increase the performance in non-VR media where gaze tracking or another source of attention data is available.

This invention is a method and device of video data compression for communication and storage that adapts the video compression according to attention data obtained from one or a multiplicity of viewers (crowd) based on but not limited to head-orientation, gaze orientation or body orientation, and furthermore tailors the resolution to each particular viewer. The video compression method preserves high resolution in areas of the video image where viewer attention is high. The video compression method also degrades resolution where attention is low. Each viewer receives compressed video data which is tailored according to his or her own need or according to anticipated need based on the angular distance between the center of their viewport and the position of portion of the video image being compressed. Video compression relies on four types of attention data. The first type is an attention data density map obtained from each viewer and based on their head, gaze or body orientation. This data may be time filtered possibly with persistence such that old data gradually decays as it is replaced by new data. Implementation of persistence can be done, for example, with an exponential filter. The second type is an aggregated (i.e., crowd-based) attention density map obtained by averaging the attention data density maps from all viewers. Each component map of the aggregate map may be differently weighed, for example according to the age, sex, nationality social status, education, or other attribute of the viewer. The third type is a rerun-aggregated attention density map which accumulates or averages aggregated attention density obtained after multiple reruns of the same video. The fourth is an anticipated-rerun-aggregated attention density map which utilizes a rerun-aggregated attention density map with a later time stamp, thereby providing viewers with enhanced resolution for particular objects in their field of view even before their need for enhanced resolution arises. This video compression scheme can be seamlessly integrated into conventional video compression processes using techniques described in the articles incorporated by reference. This video compression scheme can also be added in series with conventional video compression processes.

Optionally, advertisers can be given the opportunity to control the resolution of objects in the image seen by the viewer. They can provide their own attention density map and their own advertiser data which is used alongside the viewer's attention data and personal data to control the video's resolution.

Optionally, personal information and advertiser information can be used to define a viewer type which is used to tag the attention density map and then select these maps in the production of a viewer-tailored resolution map.

This invention is a compression scheme for compressing video data using attention data collected from one or multiple viewers. Each video frame in a video stream is assigned a time stamp. The invention comprises a server connected to a network communication system and one or several viewer display devices. The server comprises:

A receiver module receiving attention data for each video frame from each viewer.

The server also comprises an attention density map non-transitory storage which holds a video mapped version of the attention data for each video frame, thereby forming an attention density map for each viewer. The attention density map is assigned a time stamp.

The server also comprises a personal data non-transitory storage in which personal data is stored. This personal data is used to produce a personal data typing, which modulates the attention density map.

An aggregated attention density map non-transitory storage which holds an aggregated attention density map in which viewer attention density maps with similar time stamps, from multiple viewers are combined, for example, by averaging, or summing.

The server also comprises an advertiser data non-transitory storage in which advertiser data is stored. The advertiser data is used to produce an advertiser attention density map. This advertiser attention density map can be used in several ways:
1. It can be used to modulate the attention density map.
2. It can be combined into the aggregated attention density map.

A rerun-aggregated attention density map non-transitory storage which holds a rerun-aggregated attention density map. This rerun-aggregated attention density map is produced by combining aggregated attention density maps with similar time stamps and obtained from multiple reruns of the same video frame;

An anticipated-rerun-aggregated attention density map non-transitory storage which holds one of the rerun-aggregated attention density maps with a later time stamp.

The server also comprises a resolution viewer-tailoring module. This module uses or combines at least one of the attention density map; the aggregated attention density map; the rerun-aggregated attention density map; and the anticipated-rerun-aggregated attention density map. The viewer tailoring module also produces a viewer tailored resolution map, which is used to compress video data which is then sent to one or several display devices.

Each display device comprises a video decompression module which decompresses the compressed video frame. The decompressed video frame is then sent to a display. Display devices also sensors which monitor viewers' attention which is then uploaded to the server.

### BRIEF DESCRIPTION OF THE DRAWINGS

FIG. 1 provides an overview of the system including a video capture device, a network server and a multiplicity of users.

FIG. 2 illustrates the architecture of the server.

FIG. 3 shows the details of the viewer video tailoring module.

FIG. 4 shows the architecture of a display device.

FIG. 5 shows an image to be compressed.

FIG. 5A shows an attention map associated with the image.

FIG. 5B shows the compressed attention-tailored video data sent to the viewer.

### DETAILED DESCRIPTION

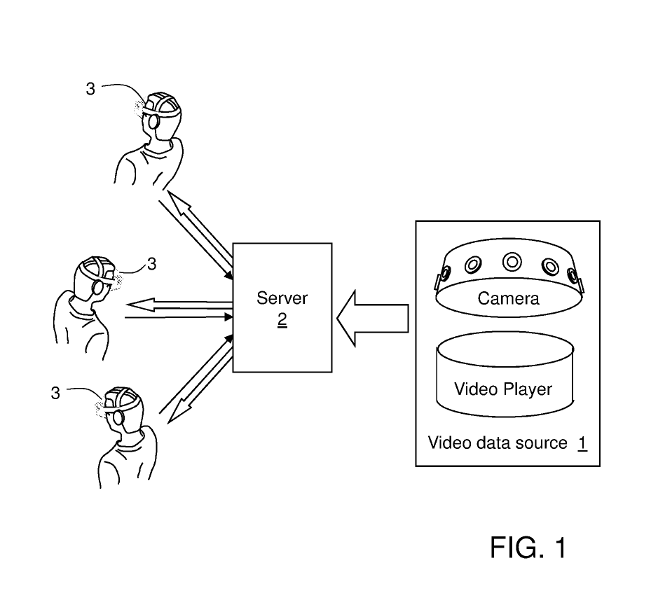

The invention comprises the following components shown in FIG. 1:
1. A video capture device 1.
2. A network server 2.
3. One or several viewer display devices 3.

The video capture device is typically located remotely from the server. In a VR environment, this device is typically a 360-degree camera.

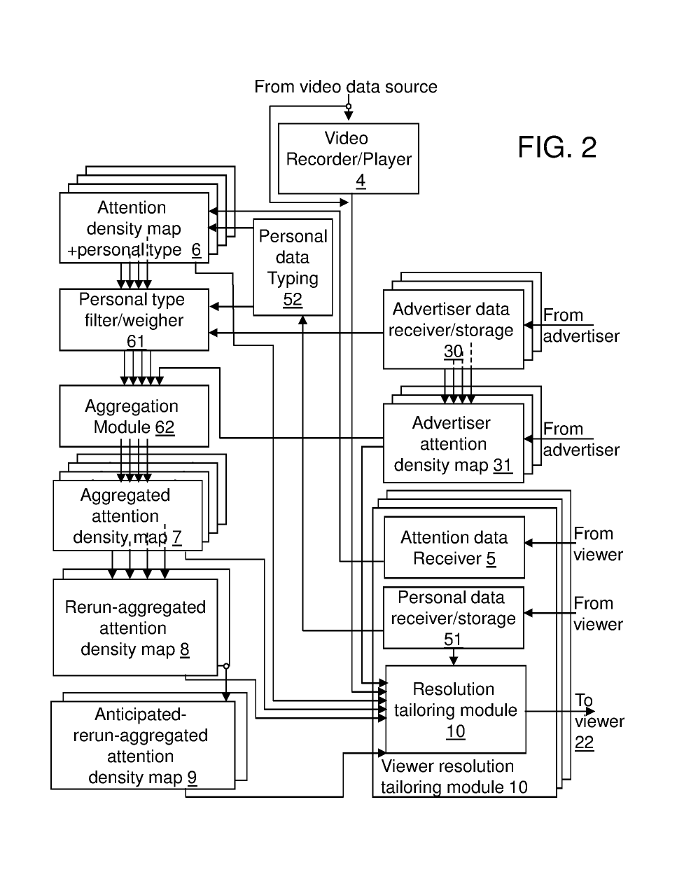

The network server is accessible through a communication network such as the internet. As shown in FIG. 2 the network server comprises the following:
1. A video recorder/player 4.
2. An attention data receiver 5.
3. A personal data receiver/storage 51.
4. An attention density map storage unit 6.
5. A personal type filter/weigher 61.
6. An aggregation module 62.
7. An aggregated attention density map storage unit 7.
8. A rerun-aggregated attention density map storage unit 8.
9. An anticipated-rerun-aggregated attention density map storage unit 9.
10. A viewer video tailoring module 10.
11. An advertiser data receiver/storage 30.
12. An advertiser attention density map 31.
13. A communication link over the network to send data to, and receive data from, viewers. If live video is used, the communication link can also be used to receive data from a camera. Otherwise recorded data is used from the video recorder/player 4.

The communication link transmits the output of the video generation device 1 (i.e., camera) to the server 2 (if live video is required).

The video recorder/player 4 records and plays the video data to and from a non-transitory medium. The recorder/player 4 can be located at the camera's 1 location or can be at the server's 1 location or recorders/players 4 can be located at both locations.

The attention data receiver 5 inputs a signal from the viewers, from which it extracts attention data 6 which contains information regarding the current locus of attention of the viewers in the video images. Attention data could be coded as a compressed video image with black pixels representing areas of focused attention and white pixels elsewhere. Alternatively, pixels can be given a numerical value indicating how long the viewer attention lingered on the pixel for a given time interval. One should note that the resolution of the attention data does not have to be as high as the resolution of the video image. For example, a square of 16 or 32 pixels of video data can be assigned a single resolution datum.

The personal data receiver/storage 51 receives and stores personal information either directly from the viewer or from a database containing the viewer's personal information. This data may include age, sex, profession, income, race, education, nationality, religion, social media friends, purchases made in the last month, last book read, or whatever is known about the viewer. This information is sent to the personal data type module 52 which converts it to a personal data type. As we shall see below, the personal data type is used to tag the attention map 6 generated by the user and refine the aggregated attention density map 7, rerun-aggregated attention density map 8, and anticipated rerun-aggregated attention map 9. These last three maps are used to generate the resolution map for the viewer.

The advertiser data receiver/storage 30 inputs information produced by the advertiser about the product being advertised. This information is used to target the advertising (which can be in a form of a better resolution for a part of the video image,) to the viewer. The information can be about the product itself, or can be about the user most likely to use the product. For example, advertising information about a hand drill at a date just before Father's Day could be in the form of personal data, such as “male,” “father,” and “between the age of 25 and 50.” Advertising information could also be “roses” just before the wedding anniversary of the viewer. Advertising information is sent to the personal typing module 52 which converts it to a personal data type. Advertising information is also sent to the advertiser attention density map 31.

The advertiser attention density map 31 is similar to the viewer density map 6 except that it is generated by the advertiser and it is used to enhance the resolution of certain parts of the video that the advertiser wishes to be enhanced. This map can be produced either by the advertiser in the same fashion that the viewer produces his map, that is with an attention sensor or can be produced from advertiser data available from the advertiser data/receiver/storage module 30. In the first case, the advertiser attention density map does not have to be produced in real time and with the same kind of attention sensors used by the viewer. For example, it can be produced off-line, by parsing the video information, possibly frame by frame, and identifying the objects in the frame that the advertiser wishes worthy of greater resolution. In the second case, raw advertiser data such as “hand drill” or “roses” can be used in conjunction with recognition software to identify the objects in the frame tagged to receive greater resolution.

The personal data type module 52 receives personal data from the personal data receiver/storage module 51 and from the advertiser receiver/storage module 30. Using this information, the personal data type module 52 produces a personal data type which is used to tag the attention density map 6 obtained from the viewer. The personal data type is also used by the personal type filter 61 to filter or weigh the attention density maps 6 being aggregated by the aggregation module 62.

The attention density map 6 contains the most recent locus history of attention of a viewer in the video image. This information is tagged according to the viewer's type generated by the personal data typing module 52. The attention density map can be based on the most current data or can be calculated for example as a decaying time average. In other words, the data represents the locus of attention with a persistence that decays according to a time constant for example ranging from 0 second to 10 seconds. Obviously, with a non-zero persistence, this data needs to be stored in a non-transitory medium. This data could be coded as a video image, the numerical value of each pixel representing the focus of attention. The resolution of the attention density map 6 does not have to be as high as the resolution of the video image.

The personal type filter/weigher produces aggregation criteria to be used by the aggregation module 62 in aggregating attention density maps. Simple binary selection and rejection correspond to weights of 1 and 0 respectively. A more complicated weighing procedure involves non-binary weights using rational numbers.

The aggregated attention density map 7 is stored on a non-transitory medium. This map is obtained by combining all viewers' attention density maps 6. This map is time stamped to mark its position in the video data stream. This data could be coded as a video image, the numerical value of each pixel representing the focus of attention. The resolution of the aggregated attention density map 7 does not have to be as high as the resolution of the video image.

The rerun-aggregated attention density map 8 is also stored in a non-transitory medium. This map is obtained by combining multiple aggregated attention density maps 7 with the same time stamp and generated by multiple reruns of the same video. This data could be coded as a video image, the numerical value of each pixel representing the focus of attention. This map is also time stamped. This map provides the system with a capability for the system to learn over time.

The anticipated-rerun-aggregated attention density map 9 is one of the rerun-aggregated attention density maps 8, selected with a later time stamp. The map can either be stored independently of the rerun-aggregated attention density maps or simply consist of one of the already stored rerun-aggregate attention density maps 8. This data could be coded as a video image, the numerical value of each pixel representing the focus of attention. The map allows the system to anticipate the viewers' need for high resolution in areas of the video image.

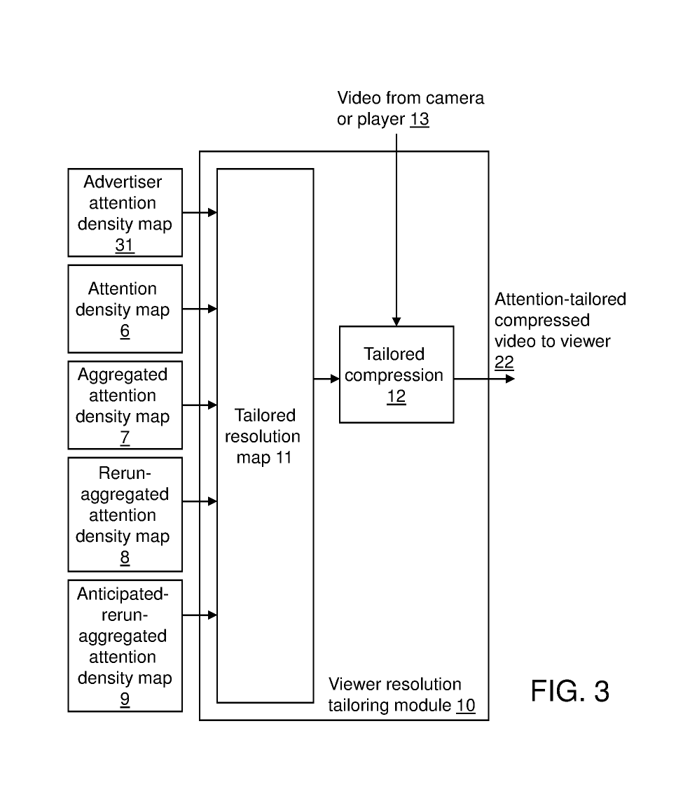

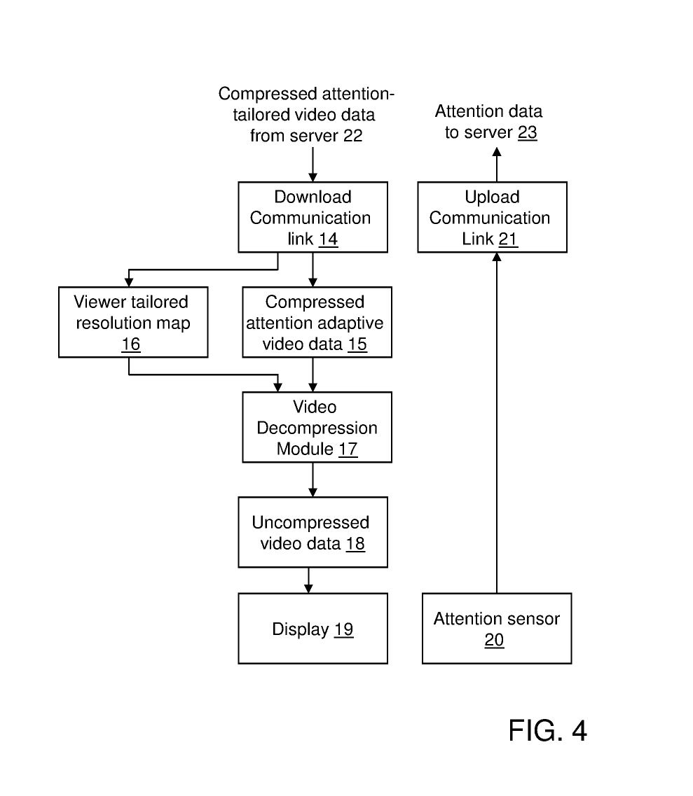

The resolution viewer resolution tailoring module 10 configures the video data to provide each viewer with the best resolution possible given the collected attention data. This module shown in detail in FIG. 3 calculates a different viewer-tailored resolution maps for each viewer. This module comprises the following:
1) Storage for the viewer-tailored resolution map 11 which is a function, (for example a weighted average) of the following:
   a. The advertiser attention density map 31.
   b. The attention density map 6.
   c. The aggregated attention density map 7.
   d. The rerun-aggregated attention density map 8.
   e. The anticipated-rerun-aggregated attention density map 9.
2) The attention tailored compression module 12 which applies the viewer tailored resolution map 11 to the video data 13 to produce an attention tailored compressed version 22 of the video which is sent to the viewer. There are many ways of compressing the video. For example, in a first approach, high resolution pixels are left intact. Lower resolution pixels sharing the same low resolution area as defined by the resolution map, are assigned their averaged value. The generation of viewer-tailored video data can be seen as an encoding process combining the raw video data with the viewer tailored resolution map. The resulting video is then compressed using a conventional video compressor and sent to the viewer. As an option, one can send along with the video, the viewer tailored resolution map to serve as a decoding key.

The communication link then transmits the attention tailored compressed video data to the viewers.

The viewer display devices comprise the following:
1. A downloading communication link 14.
2. Compressed attention-adaptive tailored video data storage 15.
3. Viewer tailored resolution map data storage 16 if this information is sent by the server, along with the video.
4. A video decompression module 17.
5. Uncompressed video data 18.
6. A display 19.
7. An attention direction sensor 20.
8. An uploading communication link 21.

The downloading communication link 14 located at the viewer's display device 3, receives the compressed attention tailored video data 22 from the server, each viewer receiving his own tailored version of the compressed attention tailored data 22.

Optionally, the viewer tailored resolution map 16 corresponding to the compressed attention tailored video data 22 is sent to each display device along with the compressed video 22 to facilitate the decompression process.

The display devices are equipped with a video decompression module 17 that restores the compressed video data to its uncompressed form possibly using the viewer tailored resolution map if available. The generation of the uncompressed video data can be seen as a decoding process.

The uncompressed video data is then conveyed to a display 19 which presents it to the viewer.

Each display device 3 is also equipped with an attention direction sensor 20. This sensor can be an eyeball direction monitoring device that measures the gaze direction of the viewer. This sensor can be a face monitoring camera that measures the direction faced by the viewer. If the viewer wears virtual reality goggles, the sensor can also be an azimuth sensor such as a compass, or a gyrocompass embedded in the body of the display, which measures the direction of the head of the viewer. The sensor can also be a camera mounted on the goggles that produces a video of the viewer's environment. The direction of the head of the viewer can be inferred by correlating the video data with known objects located in the viewer's environment. The attention direction sensor produces attention direction data 23 sent to the server.

Each display device 3 is also equipped with an uploading communication link 21 that uploads the attention direction data 23 to the attention data receiver 5 in the server. The uploaded data can be the current attention direction data or can be a filtered version of this data. For example, difference information could be transmitted representing only changes in attention direction by the user. The data could also be a combination of current data and difference data.

It is understood that the number of viewers in the above description can range from 1 to many. In the case of a single viewer, the aggregate attention density map 7 becomes identical with the viewer attention density map 6.

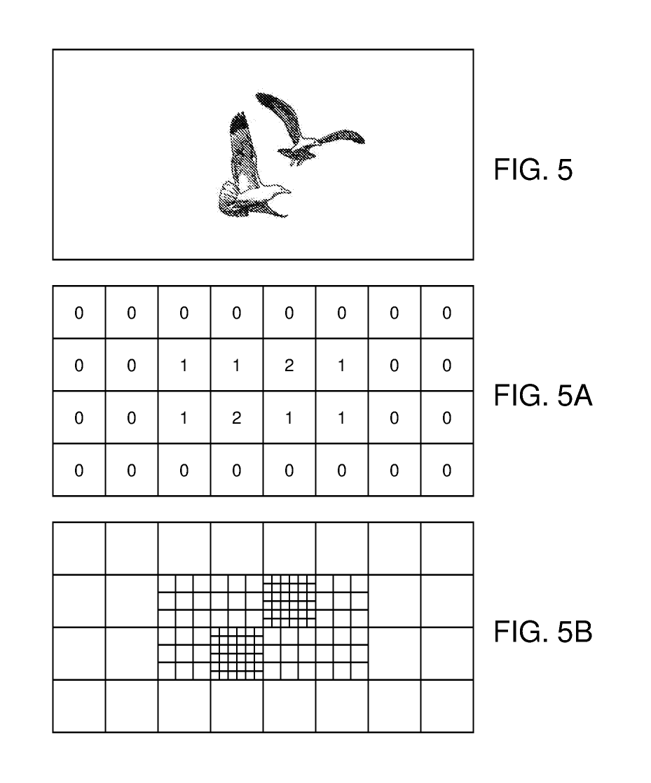

FIGS. 5, 5A and 5B illustrate how attention density maps 6, 7, 8 or 9 and a viewer tailored resolution map 11 are encoded. FIG. 5 shows a scene including two sea birds. FIG. 5A shows an attention density map 6, 7, 8, or 9 which could be from a single viewer, or could be aggregated from multiple viewers or from multiple reruns. Attention density is encoded as a numerical value associated with macroblocks. The viewer tailored resolution map 11 is produced by associating an increased resolution with an increased attention. The relationship between increased resolution and the increased attention does not have to be linear. Three levels of resolution are illustrated by FIG. 5B but obviously, the number of degree of resolution is not limited to three.

The viewer tailored resolution map 11 can then be utilized by a resolution compression algorithm such as MPEG4.

While the above description contains many specificities, the reader should not construe these as limitations on the scope of the invention, but merely as exemplifications of preferred embodiments thereof. Those skilled in the art will envision many other possible variations within its scope. Accordingly, the reader is requested to determine the scope of the invention by the appended claims and their legal equivalents, and not by the examples which have been given.

I claim:

1. A video compression scheme based on attention data from multiple viewers, said compression scheme compressing and transmitting to multiple viewers, a video stream comprised of a succession of video frames, most recent of said succession being a current video frame, said compression scheme comprised of:
a. a server connected to a network communication system;
b. multiple display devices, each said display device assigned to one of said viewers and connected to said server through said network communication system;
c. each said video frame being assigned a time stamp, said time stamp remaining constant upon a rerun of each said video frame;
d. said server comprising:
i. an attention data receiver module receiving an attention data for each said video frame, from each said display devices;
ii. a viewer attention density map non-transitory storage which holds said attention data for each said video frame, from each said viewer, thereby forming an attention density map for each viewer, said attention density map being assigned said time stamp;
iii. a viewer resolution tailoring module which uses said attention density map to produce a viewer tailored resolution map,
iv. said viewer resolution tailoring module uses said viewer tailored resolution map to compress said current video frame, said compressed current video frame being sent to at least one of said display devices; and
e. at least one of said display device comprising a video decompression module, said video decompression module producing a decompressed version of said current video frame, said decompressed video frame being displayed by said display device.

2. A video compression scheme of claim 1 wherein said server also comprises a personal data non-transitory storage in which a personal data is stored, said personal data being used to produce a personal data typing, said personal data typing used to modulate said attention density map.

3. A video compression scheme of claim 1 wherein said server also comprises an advertiser data non-transitory storage in which an advertiser data is stored, said advertiser data being used to modulate said attention density map.

4. A video compression scheme of claim 1 wherein said server also comprises:
a. an aggregated attention density map non-transitory storage in which an aggregated attention density map is stored; said aggregated attention density map being produced by combining multiple said attention density maps with similar said time stamps from multiple said viewers; and
b. furthermore, wherein said viewer resolution tailoring module combines:
i. said attention density map; and
ii. said aggregated attention density map;
to produce said viewer tailored resolution map.

5. A video compression scheme of claim 4 wherein said server also comprises:
a. an advertiser data non-transitory storage in which an advertiser data is stored, said advertiser data being used to produce an advertiser attention density map; and
b. wherein said aggregated attention density map being produced by combining:
i. multiple said attention density maps with similar said time stamps from multiple said viewers; and
ii. said advertiser attention density map.

6. A video compression scheme of claim 5 wherein said server also comprises
a. a rerun-aggregated attention density map non-transitory storage which holds a rerun-aggregated attention density map; said rerun-aggregated attention density maps produced by combining said aggregated attention density maps having similar said time stamps, obtained from multiple said reruns of each said video frame; and
b. furthermore, wherein said viewer resolution tailoring module combines at least two of:
i. said attention density map;
ii. said aggregated attention density map; and
iii. said rerun-aggregated attention density map, to produce said viewer tailored resolution map.

7. A video compression scheme of claim 6 wherein said server also comprises
a. an anticipated-rerun-aggregated attention density map non-transitory storage which holds one of said rerun-aggregated attention density map with a later said time stamp; and
b. furthermore, wherein said viewer resolution tailoring module combines at least two of:
i. said attention density map;
ii. said aggregated attention density map;
iii. said rerun-aggregated attention density map; and
iv. said anticipated rerun-aggregated attention density map, to produce said viewer tailored resolution map.

8. A video compression scheme of claim 7 wherein at least one of said display device also comprises an attention sensor producing said attention data, said attention data being uploaded to said server through said network communication system.
